(19) United States
(12) Patent Application Publication
(10) Pub. No.: US 2010/0322304 A1
(43) Pub. Date: Dec. 23, 2010

(54) MULTI-SOURCE FILTER AND FILTERING METHOD BASED ON H.264 DE-BLOCKING

(75) Inventors: Tung-Hsin Lee, Hsinchu City (TW); Chee-Boon Ng, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/581,896

(22) Filed: Oct. 20, 2009

(30) Foreign Application Priority Data
Jun. 17, 2009 (TW) 98120245

(51) Int. Cl. H04N 7/12

(52) U.S. Cl. 375/240.03; 375/E07.076

(57) ABSTRACT

A multi-source filter based on H.264 de-blocking includes the following units. A quantization parameter (qP) calculation unit receives an image data and calculates a qP. A boundary strength (bS) calculation unit receive the image data and calculates a bS. A block detector receives the image data and determines whether the image data falls in the block boundary. An image edge detector receives the image data and determines whether it is not belonged to an image edge region. An enabling unit receives the qP to determine whether to enable a de-blocking filtering operation. A determining unit filters the image data to output a new image data when determines that the image edge is not at the block boundary and the filtering operation is required.

### CROSS-REFERENCE TO RELATED APPLICATION

This application claims the priority benefit of Taiwan application serial no. 98120245, filed Jun. 17, 2009. The entirety of the above-mentioned patent application is hereby incorporated by reference herein and made a part of specification.

### BACKGROUND OF THE INVENTION

1. Field of the Invention

The present invention relates to a H.264 video compression and decompression technique. More particularly, the present invention relates to a multi-source filter based on H.264 de-blocking.

2. Description of Related Art

A H.264 video compression and decompression technique is an image compression technique provided after a moving picture experts group (MPEG) video compression and decompression technique is disclosed. In the H.264 video compression technique, one image is divided into a plurality of blocks for being respectively compressed. During a decompression process, after the blocks are respectively decompressed, a de-blocking process is performed to combine the plurality of blocks into one image.

A de-blocking function is to eliminate blocking artifacts generated during a processing of the H.264 video blocks. However, if an input image data is not directly generated by a decoder, but is an image data transmitted after being decoded, the de-blocking function of the H.264 video compression technique then cannot achieve its predetermined effectiveness.

FIG. 1 is a circuit diagram illustrating a conventional de-blocking function. Referring to FIG. 1, the image data decoded by a decoder 100 includes a quantization parameter (qP), which is obtained by a quantization parameter unit 104 and is output to a threshold unit 106. It is known by those skilled in the art that the quantization parameter represents a simplified situation of block information, and a threshold value can be obtained by looking up a table. According to the threshold value and an adopted condition, a filter switch 108 can output an enabling signal to enable a filter 110. A function of the filter 110 is to slightly blur the image of a block boundary to blur the block boundary, so that the artificial sliced blocks are not revealed on the image.

The filter 110 receives the image data (i.e. a plurality of pixel data of one frame) from an image unit 102 to perform a filtering operation. A boundary strength (bS) unit 112 obtains a bS according to information provided by the decoder 100. Further, a filtering strength of the filter 110 is determined according to a level of the boundary strength unit 112.

In the conventional structure of FIG. 1, information of the quantization parameter and the boundary strength are all provided by the decoder 110. If an image data source is not provided by the decoder 110, but is provided by a decoded image data source, since the decoded image data source does not contain the information of the quantization parameter and the boundary strength, the de-blocking function provided by the H.264 specification cannot be correctly utilized.

### SUMMARY OF THE INVENTION

The present invention is directed to a multi-source filter based on H.264 de-blocking. In which if an image data is generated by a decoder, an filtering operation is performed according to provided information of a quantization parameter and a boundary strength. If the image data is not generated by the decoder, the quantization parameter and the boundary strength are deduced according to the image data, and a de-blocking processing is performed.

The present invention provides a multi-source filter based on H.264 de-blocking, which includes a first switch unit, a second switch unit, a quantization parameter calculation unit, a boundary strength calculation unit, a block detector, an image edge detector, an enabling unit, a determining unit and a filter. The first switch unit selects to receive an original quantization parameter (qP) provided by a decoder or a calculated quantization parameter (qP′). The second switch unit selects to receive an original boundary strength (bS) provided by the decoder or a calculated boundary strength (bS′). The first switch unit and the second switch unit simultaneously select the original quantization parameter and the original boundary strength, or simultaneously select the calculated quantization parameter and the calculated boundary strength. The quantization parameter calculation unit receives an image data input thereto and calculates the calculated quantization parameter. The boundary strength calculation unit receives the image data and calculates the calculated boundary strength. The block detector receives the image data and outputs a block detecting value when determines that the image data falls in a block boundary region. The image edge detector receives the image data and outputs a non-edge detecting value when determines that the image data is not belonged to an image edge region. The enabling unit is connected to the first switch unit to receive the original quantization parameter or the calculated quantization parameter, and compares the original quantization parameter or the calculated quantization parameter to a threshold value to determine whether or not to output a filter enabling value. The determining unit receives the block detecting value, the non-edge detecting value and the filter enabling value, and outputs an enabling value according to at least one of the block detecting value, the non-edge detecting value and the filter enabling value. The filter is connected to the second switch unit to receive the enabling value, the image data, and the original boundary strength or the calculated boundary strength transmitted by the second switch unit, so as to perform a filtering operation to the image data according to the original boundary strength or the calculated boundary strength, and output a processed image data.

The present invention provides a multi-source filter based on H.264 de-blocking, which includes a quantization parameter calculation unit, a boundary strength calculation unit, a block detector, an image edge detector, an enabling unit, a determining unit and a filter. The quantization parameter calculation unit receives an image data input thereto and calculates a quantization parameter according to a first analysis rule. The boundary strength calculation unit receives the image data and calculates a boundary strength according to a second analysis rule. The block detector receives the image data and outputs a block detecting value when determines that the image data falls in a block boundary region. The image edge detector receives the image data and outputs a non-edge detecting value when determines that the image data is not belonged to an image edge region. The enabling unit receives the quantization parameter and compares the quantization parameter to a threshold value, so as to output a filter enabling value. The determining unit receives the block detecting value, the non-edge detecting value and the filter enabling value, and outputs an enabling value when the block detecting value, the non-edge detecting value and the filter enabling value are all in an enabling state. The filter receives the enabling value, the image data, and the boundary strength, and performs a filtering operation to the image data according to the boundary strength, so as to output a processed image data.

The present invention provides a quantization parameter generation circuit adapted to a H.264 image processing, which includes a first variance calculation unit, a second variance calculation unit, a maximum value obtaining unit and a value scaling unit. The first variance calculation unit obtains n adjacent pixel values of a first side according to a designated block boundary to perform a variance calculation, so as to obtain a first variance. The second variance calculation unit obtains n adjacent pixel values of a second side according to the block boundary to perform the variance calculation, so as to obtain a second variance. The maximum value obtaining unit obtains a greater value from the first variance and the second variance. The value scaling unit scales the greater value to output the calculated quantization parameter. Wherein, n is not less than 3.

The present invention provides a boundary strength generation circuit adapted to a H.264 image processing, which includes a luminance shielding estimation unit, a minimum value obtaining unit, a difference calculation unit and a logarithm calculation unit. According to an assumed block boundary, the luminance shielding estimation unit obtains a first luminance resolution value and a second luminance resolution value corresponding to two pixel luminance values of two adjacent pixels of the assumed block boundary. The minimum value obtaining unit obtains a smaller value from the first luminance resolution value and the second luminance resolution value. The difference calculation unit calculates a difference value of the two pixel luminance values. The algorithm calculation unit calculates the calculated boundary strength according to the difference value and the smaller value.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram illustrating a conventional de-blocking function.

FIG. 2 is a schematic diagram illustrating a multi-source filter based on H.264 de-blocking according to an embodiment of the present invention.

FIG. 3 is a schematic diagram illustrating a mechanism of calculating a quantization parameter according to an embodiment of the present invention.

FIG. 4 is a circuit diagram illustrating a quantization parameter calculation unit according to an embodiment of the present invention.

FIG. 5 is a schematic diagram illustrating a boundary strength calculation unit according to an embodiment of the present invention.

### DESCRIPTION OF THE EMBODIMENTS

The present invention provides a multi-source filter based on H.264 de-blocking, which can process information of a quantization parameter qP and a boundary strength bS obtained from a decoder, and can also deduce information of a calculated quantization parameter qP′ and a calculated boundary strength bS′ according to the image data, so as to use a H.264 de-blocking function. Moreover, a block detector is used to determine a block position, and an image edge detector is used to determine whether or not to enable a filter, wherein when an image edge is located at the block boundary, the filter is not enabled.

Embodiments are provided below for describing the present invention in detail, thought the present invention is not limited to the provided embodiments, and the provided embodiments can be mutually combined, suitably.

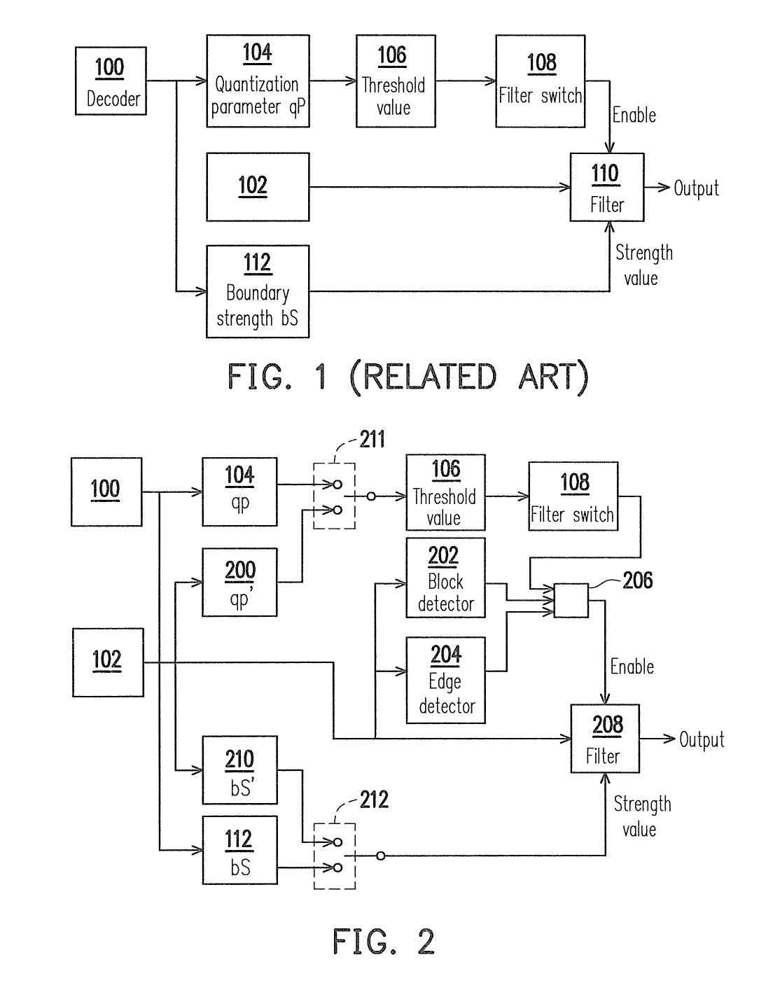

FIG. 2 is a schematic diagram illustrating a multi-source filter based on H.264 de-blocking according to an embodiment of the present invention. Referring to FIG. 2, generally, the multi-source filter includes a first switch unit 211, a second switch unit 212, a quantization parameter calculation unit 200, a boundary strength calculation unit 210, a block detector 202, an image edge detector 204, an enabling unit 106+108, a determining unit 206 and a filter 208. Moreover, a quantization parameter unit 104, a boundary strength unit 112, a threshold unit 106 and a filter switch 108 have the same functions as that described in the embodiment of FIG. 1.

The first switch unit 211 selects to receive an original quantization parameter qP provided by a decoder 100 or a calculated quantization parameter qP′ provided by the quantization parameter calculation unit 200. The second switch unit 212 selects to receive an original boundary strength bS provided by the decoder 100 or a calculated boundary strength bS′ provided by the boundary strength calculation unit 210. The first switch unit 211 and the second switch unit 212 simultaneously select the original quantization parameter qP and the original boundary strength bS, or simultaneously select the calculated quantization parameter qP′ and the calculated boundary strength bS′.

The quantization parameter calculation unit 200 receives an image data from an image unit 102, and since the image data is a decoded image data, it does not contain information of the quantization parameter qP and the boundary strength bS. Now, the quantization parameter calculation unit 200 calculates the calculated quantization parameter qP′. The boundary strength calculation unit 210 also receives the image data and calculates the calculated boundary strength bS′.

Moreover, the block detector 202 also receives the image data, and outputs a block detecting value when determines that the image data falls in a block boundary region. The image edge detector 204 receives the image data, and outputs a non-edge detecting value when determines that the image data is not belonged to an image edge region. The enabling unit includes the threshold unit 106 and the filter switch 108, and the enabling unit is connected to the first switch unit 211 for receiving the original quantization parameter qP or the calculated quantization parameter qP′, and the enabling unit obtains a threshold value by looking up a table, so as to correspondingly output a filter enabling value. The block detector 202 and the image edge detector 204 are belonged to existing techniques and are unnecessary to be individually limited.

In the present embodiment, the determining unit 206 receives the block detecting value, the non-edge detecting value and the filter enabling value, and outputs an enabling value according to the following conditions. (1) if the filter enabling value is determined by the original quantization parameter qP, the enabling value is output to the filter 208 only according to the filter enabling value, so as to determine whether or not to enable the filter 208. (2) if the filter enabling value is determined by the calculated quantization parameter qP′, the enabling value is output only when the block detecting value, the non-edge detecting value and the filter enabling value are all in an enabling state. This is because the image edge is a main part of the image, which is required to be clearly displayed. Therefore, when the image edge is located at the block boundary, if the filter performs a blurring operation, the image edge is blurred, so that in case of the image edge, the filter enabling value is not a representative value of the enabling state, and now the filter 208 does not perform a filtering operation.

In an actual application, implementation of the determining unit 206 is not difficult. For example, the determining unit 206 can receive a same control operation (for example, receive a same control signal) as that of the switch units 211 and 212, so as to determine whether the quantization parameter received from the front-end is qP or qP′. Then, according to different conditions (1) and (2), the determining unit 206 determines whether or not to enable the filter 208 according to different approaches. For example, the determining unit 206 may include a logic circuit (for example, an AND gate), wherein input terminals thereof respectively receive the block detecting value, the non-edge detecting value and the filter enabling value, and in case of the condition (2), the determining unit 206 determines whether or not to enable the filter 208 according to signal values of the three received values. Certainly, implementation of the determining unit 206 is not limited to the above example, and as long as a circuit or a method can execute the corresponding operations according to the aforementioned different conditions (1) and (2), it is construed to be within the scope of the present invention.

The filter 208 receives the enabling value, the image data, and the original boundary strength bS/the calculated boundary strength bS′ transmitted from the second switch unit 212, and performs a filtering operation in response to the enabling value, so as to output a processed image data.

Regarding the functional blocks of FIG. 2, a plurality of the functional blocks can be integrated according to an actual demand of a circuit designer, and a structure thereof is not limited to the functional blocks shown in FIG. 2, while such variation is still construed to be within the scope of the present invention.

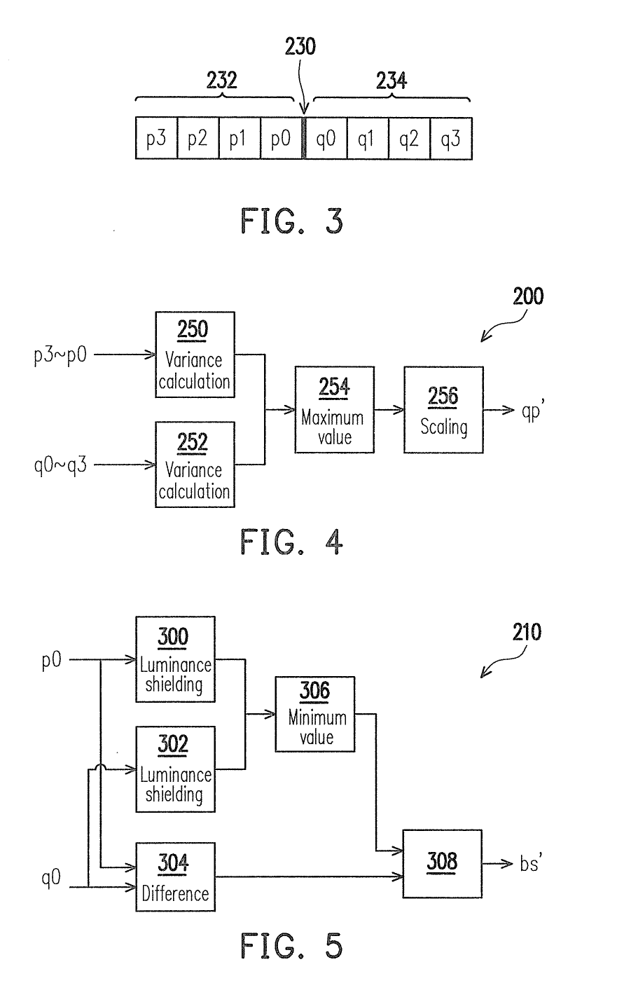

Next, a circuit structure and a calculation mechanism of the quantization parameter calculation unit 200 are described. FIG. 3 is a schematic diagram illustrating a mechanism of calculating the quantization parameter according to an embodiment of the present invention, and FIG. 4 is a circuit diagram illustrating the quantization parameter calculation unit 200 according to an embodiment of the present invention. Referring to FIG. 3 and FIG. 4, the quantization parameter can influence sacrificed details of a block content. Therefore, calculation of the qP′ is to use the details to estimate the original quantization parameter qP. Regarding an assumed block boundary 230, at least 3 pixels 232 (for example, 4 pixels p0-p3) at the left side can be obtained, and meanwhile at least 3 pixels 234 (for example, 4 pixels q0-q3) at the right side can be obtained. The variance calculation units 250 and 252 respectively calculate different variances. Different mechanisms can be applied to calculate the variances. In the present invention, a high-pass filter (particularly, a second-order [−1, 2, −1] high-pass filter) is used for the calculation. Generally, the variance is varied along with a disorder degree of the image, and the calculated variance can approximately represent the disorder degree of the image. A maximum value obtaining unit obtains a maximum value from the calculated variances of the left side and the right side, and such maximum value represents a variance amount of the left and the right sides of the block boundary. A scaling unit 256 scales the maximum value to obtain the aforementioned calculated quantization parameter qP′, so as to replace the original quantization parameter qP.

Next, FIG. 5 is a schematic diagram illustrating a boundary strength calculation unit according to an embodiment of the present invention. Referring to FIG. 5, a mechanism of the boundary strength calculation unit can be implemented according to a visual recognition difference of luminance. Since a slight luminance difference cannot be recognized by vision, a luminance range that cannot be recognized by the vision is referred to as a shielding range or a luminance resolution, and each luminance corresponds to a different luminance resolution. For example, regarding a specific luminance A, the corresponding luminance resolution (the luminance difference that cannot be recognized by the vision) thereof can be A1, and regarding another specific luminance B, the corresponding luminance resolution thereof can be B1. It should be noticed that a relation between a specific luminance and the corresponding luminance resolution and values thereof can be obtained according to a general research information.

In the present embodiment, two adjacent pixels p0 and q0 of the block boundary 230 (referring to FIG. 3) are used to respectively estimate the luminance resolutions through luminance shielding units 300 and 302, and a minimum value obtaining unit 306 obtains a smaller value from the two luminance resolutions to serve as a luminance recognizable value. Further, a difference calculation unit 304 calculates the luminance difference of the pixels p0 and q0. Then, a boundary strength estimation unit 308 analyses the calculated boundary strength bS′ corresponding to the original boundary strength bS. For example, the calculated boundary strength bS′ is obtained according to a following equation (1):

Log₂(luminance difference value/the smaller luminance resolution). (1)

However, if a more accurate adjustment is required, a calculation result of the equation (1) can be further adjusted.

It should be noticed that the present invention provides a method of estimating the calculated quantization parameter qP′ and the calculated boundary strength bS′ at the block boundary. Therefore, if the image data does not contain the original quantization parameter qP and the original boundary strength bS, the substituted qP′ and bS′ can be estimated according to the image data, so as to perform a filtering operation or a burring processing to the block boundary.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multi-source filter based on H.264 de-blocking, comprising:
a first switch unit, for selecting to receive an original quantization parameter (qP) provided by a decoder or a calculated quantization parameter (qP′);
a second switch unit, selecting to receive an original boundary strength (bS) provided by the decoder or a calculated boundary strength (bS′), wherein the first switch unit and the second switch unit simultaneously select the original quantization parameter and the original boundary strength, or simultaneously select the calculated quantization parameter and the calculated boundary strength;
a quantization parameter calculation unit, receiving an image data input thereto and calculating the calculated quantization parameter;
a boundary strength calculation unit, receiving the image data and calculating the calculated boundary strength;
a block detector, receiving the image data and outputting a block detecting value when determines that the image data falls in a block boundary region;
an image edge detector, receiving the image data and outputting a non-edge detecting value when determines that the image data is not belonged to an image edge region;
an enabling unit, connected to the first switch unit to receive the original quantization parameter or the calculated quantization parameter, for comparing the original quantization parameter or the calculated quantization parameter with a threshold value, so as to determine whether or not to output a filter enabling value;
a determining unit, receiving the block detecting value, the non-edge detecting value and the filter enabling value, and outputting an enabling value according to at least one of the block detecting value, the non-edge detecting value and the filter enabling value; and
a filter, connected to the second switch unit, for receiving the enabling value, the image data, and the original boundary strength or the calculated boundary strength transmitted by the second switch unit, so as to perform a filtering operation to the image data according to the original boundary strength or the calculated boundary strength, and output a processed image data.

2. The multi-source filter based on H.264 de-blocking as claimed in claim 1, wherein if the first switch unit transmits the original quantization parameter, the determining unit outputs the enabling value only according to the filter enabling value.

3. The multi-source filter based on H.264 de-blocking as claimed in claim 1, wherein if the first switch unit transmits the calculated quantization parameter, the determining unit outputs the enabling value only when the block detecting value, the non-edge detecting value and the filter enabling value are all in an enabling state.

4. The multi-source filter based on H.264 de-blocking as claimed in claim 1, wherein the quantization parameter calculation unit comprises:
a first variance calculation unit, performing a variance calculation on n adjacent pixel values of a first side according to an assumed block boundary, so as to obtain a first variance;
a second variance calculation unit, obtaining n adjacent pixel values of a second side according to the assumed block boundary to perform the variance calculation, so as to obtain a second variance;
a maximum value obtaining unit, obtaining a greater value from the first variance and the second variance; and
a value scaling unit, scaling the greater value to output the calculated quantization parameter,
wherein n is not less than 3.

5. The multi-source filter based on H.264 de-blocking as claimed in claim 4, wherein the variance calculation is a high-pass filter calculation.

6. The multi-source filter based on H.264 de-blocking as claimed in claim 4, wherein n=4.

7. The multi-source filter based on H.264 de-blocking as claimed in claim 1, wherein the boundary strength calculation unit comprises:
a luminance shielding estimation unit, obtaining a first luminance resolution value and a second luminance resolution value corresponding to two pixel luminance values of two adjacent pixels of an assumed block boundary;
a minimum value obtaining unit, obtaining a smaller value from the first luminance resolution value and the second luminance resolution value;
a difference calculation unit, calculating a difference value of the two pixel luminance values; and
a logarithm calculation unit, calculating the calculated boundary strength according to the difference value and the smaller value.

8. A multi-source filter based on H.264 de-blocking, comprising:
a quantization parameter calculation unit, receiving an image data input thereto and calculating a quantization parameter according to a first analysis rule;
a boundary strength calculation unit, receiving the image data and calculating a boundary strength according to a second analysis rule;
a block detector, receiving the image data and outputting a block detecting value when determines that the image data falls in a block boundary region;
an image edge detector, receiving the image data and outputting a non-edge detecting value when determines that the image data is not belonged to an image edge region;
an enabling unit, receiving the quantization parameter and comparing the quantization parameter with a threshold value, so as to output a filter enabling value;
a determining unit, receiving the block detecting value, the non-edge detecting value and the filter enabling value, and outputting an enabling value when the block detecting value, the non-edge detecting value and the filter enabling value are all in an enabling state;
a filter, receiving the enabling value, the image data, and the boundary strength, and performing a filtering operation to the image data according to the boundary strength, so as to output a processed image data.

9. The multi-source filter based on H.264 de-blocking as claimed in claim 8, wherein the quantization parameter calculation unit comprises:
a first variance calculation unit, obtaining n adjacent pixel values of a first side according to an assumed block boundary to perform a variance calculation, so as to obtain a first variance;
a second variance calculation unit, performing the variance calculation on n adjacent pixel values of a second side according to the assumed block boundary, so as to obtain a second variance;
a maximum value obtaining unit, obtaining a greater value from the first variance and the second variance; and
a value scaling unit, scaling the greater value to output the quantization parameter,
wherein n is not less than 3.

10. The multi-source filter based on H.264 de-blocking as claimed in claim 9, wherein the variance calculation is a high-pass filter calculation.

11. The multi-source filter based on H.264 de-blocking as claimed in claim 9, wherein n=4.

12. The multi-source filter based on H.264 de-blocking as claimed in claim 8, wherein the boundary strength calculation unit comprises:
a luminance shielding estimation unit, obtaining a first luminance resolution value and a second luminance resolution value corresponding to two pixel luminance values of two adjacent pixels of an assumed block boundary;
a minimum value obtaining unit, obtaining a smaller value from the first luminance resolution value and the second luminance resolution value;
a difference calculation unit, calculating a difference value of the two pixel luminance values; and
a logarithm calculation unit, calculating the boundary strength according to the difference value and the smaller value.

13. A quantization parameter generation circuit, adapted to a H.264 image processing, and comprising:
a first variance calculation unit, performing a variance calculation n adjacent pixel values of a first side according to a designated block boundary, so as to obtain a first variance;
a second variance calculation unit, performing the variance calculation on n adjacent pixel values of a second side according to the designated block boundary, so as to obtain a second variance;
a maximum value obtaining unit, obtaining a greater value from the first variance and the second variance; and
a value scaling unit, scaling the greater value to obtain a quantization parameter,
wherein n is not less than 3.

14. The quantization parameter generation circuit as claimed in claim 13, wherein the variance calculation is a high-pass filter calculation.

15. The quantization parameter generation circuit as claimed in claim 13, wherein n=4.

16. A boundary strength generation circuit, adapted to a H.264 image processing, comprising:
a luminance shielding estimation unit, obtaining a first luminance resolution value and a second luminance resolution value corresponding to two pixel luminance values of two adjacent pixels of an assumed block boundary;
a minimum value obtaining unit, obtaining a smaller value from the first luminance resolution value and the second luminance resolution value;
a difference calculation unit, calculating a difference value of the two pixel luminance values; and
a logarithm calculation unit, calculating a boundary strength according to the difference value and the smaller value.
